(19) United States
(12) Patent Application Publication
(10) Pub. No.: US 2015/0368049 A1
(43) Pub. Date: Dec. 24, 2015

(54) LINEAR CROSS-BELT SORTER USING ELECTRO-ADHESION

(71) Applicant: Dematic Corp., Grand Rapids, MI (US)

(72) Inventor: David M. Berghorn, Grand Rapids, MI (US)

(21) Appl. No.: 14/734,645

(22) Filed: Jun. 9, 2015

Related U.S. Application Data
(60) Provisional application No. 62/014,894, filed on Jun. 20, 2014.

(51) Int. Cl. B65G 47/64; B65G 15/58

(52) U.S. Cl. CPC B65G 47/646; B65G 15/58

(57) ABSTRACT

An article sorter and method of sorting articles includes a conveyor having a conveying surface travelling in a longitudinal direction and a plurality of lanes extending laterally from the conveyor. A plurality of tilting devices are each adapted to tilt the conveying surface in the direction of one of the lanes in order to discharge an article to that lane. An electro-adhesion system is adapted to be applied to the conveying surface adjacent to at least one of the lanes in order to retain an article at the conveying surface while the conveying surface is being tilted by one of the tilting devices to discharge another article.

### CROSS REFERENCE TO RELATED APPLICATION

This application claims priority from U.S. patent application Serial No. 62/014,894, filed on Jun. 20, 2014, the disclosure of which is hereby incorporated herein by reference.

### BACKGROUND OF THE INVENTION

The present invention is directed to a sortation system and method and, in particular, to a sortation system and method for laterally diverting articles from a conveyor. The sortation may be unidirectionally to one lateral side of the conveyor or bi-directionally to opposite lateral sides of the conveyor.

### SUMMARY OF THE INVENTION

An article sorter and method of sorting articles, according to an aspect of the invention, includes a conveyor having a conveying surface travelling in a longitudinal direction and a plurality of lanes extending laterally from the conveyor. A plurality of tilting devices are each adapted to tilt the conveying surface in the direction of one of the lanes in order to discharge an article to that lane. An electro-adhesion system is adapted to be applied to the conveying surface adjacent to at least one of the lanes in order to retain an article at the conveying surface while the conveying surface is being tilted by one of the tilting devices to discharge another article.

These and other objects, advantages and features of this invention will become apparent upon review of the following specification in conjunction with the drawings.

### BRIEF DESCRIPTION OF THE DRAWINGS

FIG. 1 is a perspective view of an article sorter and method of sortation according to an embodiment of the invention.

### DESCRIPTION OF THE PREFERRED EMBODIMENT

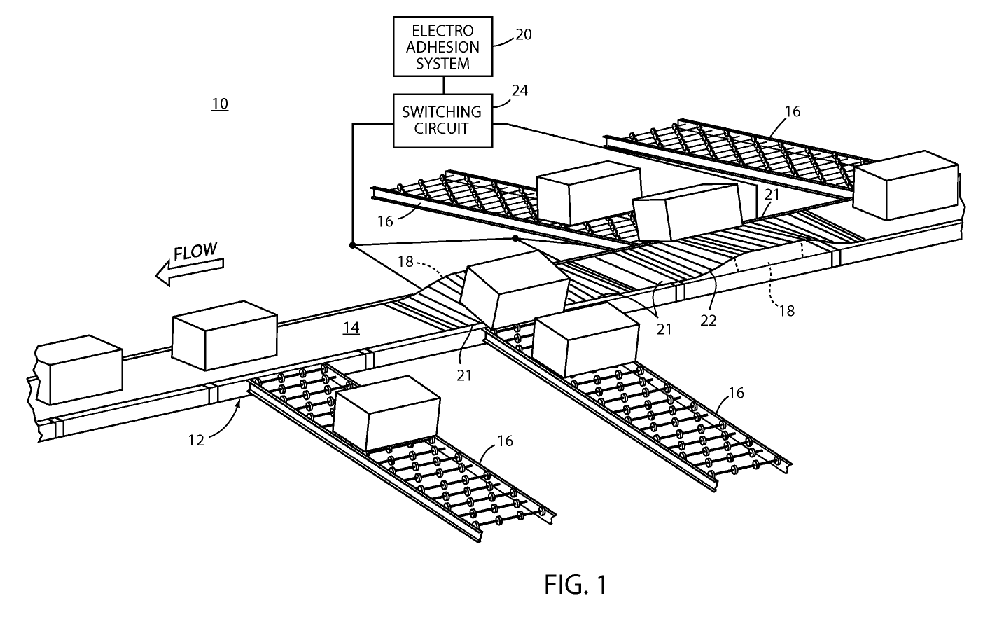

Referring now to the drawings and the illustrative embodiments depicted therein, a sorter 10 includes a conveyor 12 having a conveying surface 14 travelling in a longitudinal direction and a plurality of lanes 16 extending laterally from conveyor 12 (FIG. 1). A plurality of tilting devices 18 are provided, one at each of lanes 16. Each tilting device 18 is adapted to tilt conveying surface 14 in the direction of one of lanes in order to discharge an article to that lane by causing an article to slide off from conveying surface 14 onto the adjacent lane 16. Lanes 16 can be various forms of driven or gravity conveyors, chutes, or the like. An electro-adhesion system 20 is selectively applied to conveying surface 14 in a region 21 of conveying surface 14 adjacent to one of lanes 16 in order to retain an article at conveying surface 14 at region 21 while the conveying surface is being tilted at that lane by one of tilting devices 18 to discharge another article. In this manner, articles can be closely spaced on conveying surface 14 and still be capable of sortation to one of lanes 16 while an adjacent article is retained on the conveying surface. Also, conveying surface 14 can be provided in longer runs thus reducing the number of drives for the conveyor while still allowing articles to be laterally diverted from the conveying surface.

In the illustrated embodiment, conveying surface 14 is defined by the upper surface of a conveyor belt 22. Conveyor belt 22 is propelled in the longitudinal direction using conventional techniques. Each tilting device 18 applies a lifting force to conveyor belt 22 in the direction of one of the lanes 16. Tilting devices 18 may be selectively activated using pneumatic actuation, electrical actuation, hydraulic actuation, or the like. As seen in FIG. 1, some of lanes 16 extend in one lateral direction from conveyor 12 and other of lanes 16 extend in an opposite lateral direction from conveyor 12. Some tilting devices 18 are capable of tilting conveying surface 14 in one lateral direction in order to discharge articles to lanes on one lateral side of conveyor 12, and some tilting devices 18 are capable of tilting conveying surface 14 in an opposite lateral direction in order to discharge articles to lanes on an opposite lateral side of conveyor 12. Although not illustrated, it is possible to have bi-directionally operated tilting devices that can selectively tilt conveying surface 14 in opposite directions so that some lanes 16 can be directly across from each other on opposite sides of conveyor 12. As illustrated in FIG. 1, the conveying surface may be substantially linear in whole or in part. However, conveying surface 14 may alternatively be circuitous, such as a circle shape, oval shape, or some combination of both.

Electro-adhesion system 20 is of the type marketed by Grabit, Inc. and is described in more detail in U.S. Pat. Nos. 7,551,419; 7,773,363; 8,125,758; 8,325,458; 8,564,926; and 8,665,578, the disclosures of which are hereby collectively incorporated herein by reference in their entirety. Electro-adhesion system 20 can be selectively applied to a region 21 of conveyor belt 22 concurrently with actuation of an adjacent tilting device 18, such as using an electrical switching circuit 24 which may control both the application of the electro-adhesion system and operation of tilting devices 18.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. An article sorter comprising:
a conveyor having a conveying surface travelling in a longitudinal direction;
a plurality of lanes extending laterally from said conveyor;
a plurality of tilting devices each adapted to tilt the conveying surface in the direction of one of said lanes in order to discharge an article to that lane; and
an electro-adhesion system that is adapted to be applied to said conveying surface adjacent to at least one of said lanes in order to retain an article at the conveying surface while said conveying surface is being tilted by one of said tilting devices to discharge another article.

2. The sorter as claimed in claim 1 wherein said conveying surface is defined by a conveyor belt.

3. The sorter as claimed in claim 2 wherein said tilting device applies a lifting force to said conveyor belt.

4. The sorter as claimed in claim 1 wherein some of said lanes extend in one lateral direction from said conveyor and other of said lanes extend in an opposite lateral direction from said conveyor.

5. The sorter as claimed in claim 4 wherein at least some of said tilting devices are adapted to tilt in both lateral directions in order to discharge articles to lanes that extend in opposite lateral directions from said conveyor.

6. The sorter as claimed in claim 1 wherein said conveying surface is substantially linear at least in part.

7. The sorter as claimed in claim 1 wherein said conveying surface is circuitous at least in part.

8. A method of sorting articles to different lanes from a conveyor having a conveying surface travelling in a longitudinal direction and a plurality of said lanes extending laterally from said conveyor, said method comprising:
tilting the conveying surface in the direction of one of said lanes in order to discharge an article to that lane; and
applying electro-adhesion to said conveying surface adjacent to at least one of said lanes in order to retain an article at the conveying surface while said conveying surface is being tilted to discharge another article.

9. The method as claimed in claim 8 wherein said conveying surface is defined by a conveyor belt and wherein said applying electro-adhesion comprises connecting an electro-adhesion system to said conveyor belt.

10. The method as claimed in claim 9 wherein said tilting comprises applying a lifting force to said conveyor belt.

11. The method as claimed in claim 8 wherein some of said lanes extend in one lateral direction from said conveyor and other of said lanes extend in an opposite lateral direction from said conveyor.

12. The method as claimed in claim 11 wherein said tilting includes tilting in one of said opposite lateral directions in order to discharge articles to lanes that extend in opposite lateral directions from said conveyor.

13. The method as claimed in claim 1 wherein said conveying surface is substantially linear at least in part.

14. The method as claimed in claim 8 wherein said conveying surface is circuitous at least in part.
